(19) United States
(12) Patent Application Publication
(10) Pub. No.: US 2005/0181092 A1
(43) Pub. Date: Aug. 18, 2005

(54) Concentrated-protein food product and process

(76) Inventor: Ronald A. Achs, Sun Valley, ID (US)

Correspondence Address: BLACK LOWE & GRAHAM, PLLC, 701 FIFTH AVENUE, SUITE 4800, SEATTLE, WA, 98104, US

(21) Appl. No.: 10/940,195

(22) Filed: Sep. 13, 2004

Related U.S. Application Data
(60) Provisional application No. 60/546,079, filed on Feb. 18, 2004.
(60) Provisional application No. 60/546,544, filed on Feb. 20, 2004.

(51) Int. Cl. A23C 9/12

(52) U.S. Cl. 426/34

(57) ABSTRACT

A system, processes, and milk-based food products made from the system and processes, in which cream is separated from milk to produce an ultra-low fat milk product. The milk product is microfiltered to produce a retentate that is ready to drink and is high in protein and has no or substantially no fat. The permeate from the microfiltration process is ultrafiltered to produce a retentate that is high in protein with few other solids. The permeate may be used to provide protein fortification to other food and beverage products, and is especially useful in its liquid form for such fortification.

### PRIORITY CLAIM

This application claims the benefit of provisional application Ser. No. 60/546,079, filed Feb. 18, 2004, and Ser. No. 60/546,544, filed Feb. 20, 2004, which are hereby incorporated by reference.

### FIELD OF THE INVENTION

This invention relates generally to methods and systems for producing milk-based food and beverages, and the food and beverage compositions produced using those systems and methods.

### BACKGROUND OF THE INVENTION

Prior art methods for producing protein fortified liquid products use two or more facilities prior to end product distribution. As illustrated in FIG. 1 the primary milk processing facility initiates the milk protein rendering process; the secondary or further processing segment formulates the end products; and a third facility typically coordinates product distribution.

Presently, Concentrated Milk Proteins, or CMPs, are processed into powder to accommodate efficient delivery of the derived proteins to other facilities. The CMPs are then reconstituted via “Sodium Caseinate” into a liquid form for further processing into a desired end-product. Rendering the CMPs into a powder includes evaporating the moist emulsifier-mated protein product by employing heat and chemical treatments. Throughout this process of drying, the emulsifier-mated protein molecules are damaged, degrading the proteins overall quality and physical structure. After drying, the powdered emulsifier-mated protein must be packaged for distribution.

Furthermore, because current systems may require two or three facilities and one or more of those facilities may not be USDA approved, the ability to produce USDA approved products is lost. With the use of two or more facilities, capital investment for the processing and manufacturing plants is also much higher and operating expenses increase proportionately.

There is therefore a need for a system that can provide one or more advantages in eliminating the need for multiple facilities, consolidating processing equipment, increasing opportunities for USDA approval, reducing risk of contamination, and eliminating the need for drying and rendering CMPs into powdered form and then emulsifying it to add it to the consumable products.

The dairy industry has long followed the above process when seeking to produce foods fortified with milk solids. At the same time, it has used various forms of filtration in order to separate cream and to produce standard beverages such as low fat milk or skim milk. In the course of separating cream from whole milk, milk having varying levels of fat and other components is produced. Depending on the process employed, the milk may be, for example, two percent or skim milk. In some cases, the production of cream having particular characteristics may produce a retentate that does not meet the definition of skim milk or other well-defined milk products. If so, the retentate might be discarded as waste or dried as described above in order to obtain certain milk solids. There is a further need, then, for a system that enables the suitable use of such retentates in direct consumable beverages or in the direct production of other food products.

### SUMMARY OF THE INVENTION

Preferred embodiments of the present invention include systems, processes, and milk-based food and beverage products made from the systems and processes, in which cream is separated from milk to produce an ultra-low fat milk product. Ideally, the cream is separated such that about 44 percent of the milk fat has been removed from the original whole milk.

The milk product with the cream removed is microfiltered to produce a retentate that is ready to drink and is high in protein and has no or substantially no fat. The milk product has a mouth feel similar to other whole or full-fat milk, even though it has essentially no fat.

The permeate from the microfiltration process is ultrafiltered to produce another retentate stream that isolates serum proteins. This retentate may be used to provide protein fortification to other food and beverage products, and is especially useful in its liquid form for such fortification.

### BRIEF DESCRIPTION OF THE DRAWINGS

The preferred and alternative embodiments of the present invention are described in detail below with reference to the following drawings.

FIG. 1 depicts a prior art method for producing fortified liquid dairy products;

FIG. 2 depicts a general flow diagram for one embodiment of the present invention;

FIG. 3A is a table indicating a preferred component table for a milk-based liquid after pasteurization and cream separation;

FIG. 3B is a table indicating a preferred component table for a milk-based liquid after microfiltration of the product indicated in FIG. 3A;

FIG. 3C is a table indicating a preferred component table for a milk-based liquid beverage;

FIG. 3D is a table indicating a preferred component table for a milk-based liquid beverage;

FIG. 3E is a table indicating a preferred component table for a milk-based liquid beverage;

FIG. 4 is a schematic diagram for a preferred system for producing milk-based products;

FIG. 5A is a diagram showing component tables corresponding to some of the processes within the system of FIG. 4;

FIG. 5B is a diagram showing component tables corresponding to some of the processes within the system of FIG. 4;

FIG. 5C is a diagram showing component tables corresponding to some of the processes within the system of FIG. 4

FIG. 6 is a flow diagram illustrating a preferred method of producing milk-based products;

FIG. 7 is a flow diagram illustrating a preferred method of producing milk-based products; and

FIG. 8 is a flow diagram illustrating a preferred method of producing milk-based products.

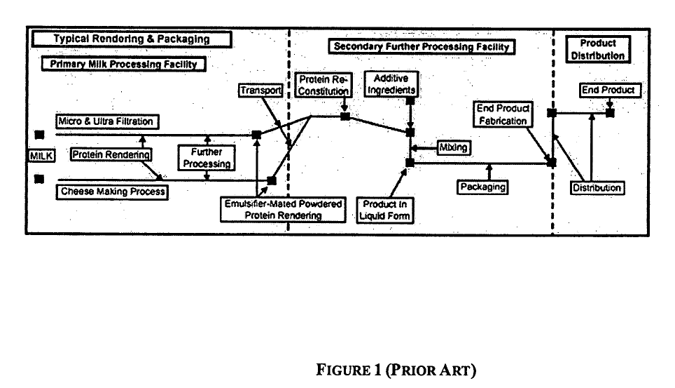

### DETAILED DESCRIPTION OF THE PREFERRED EMBODIMENT

The preferred embodiment of the present invention provides for isolating, concentrating, pasteurizing, processing, and packaging component naturally occurring milk proteins in such a manner that direct salable products and products that can be used as ingredients for direct salable goods are produced. Among the benefits of certain embodiments of the system is to eliminate the risk of contamination to the Concentrated Milk Proteins (“CMP”) often associated with distribution oriented packaging. Since all CMP rendering, further processing and packaging is located in one facility, the plant using the invention can also operate much more efficiently and can petition to have its process and products manufactured in a “USDA Approved” facility—an option that may not be exercised by prior methods, which use multiple facilities for different segments of end product production.

Since the CMPs in the preferred embodiment are directly routed in liquid form, the need to further process the CMPs by employing damaging emulsifiers (Sodium or Calcium) mated to the milk protein molecules is eliminated. The emulsifiers are needed to reconstitute powdered protein into a useable liquid form for further processing—a step that is required in the prior methods—and the mating of emulsifiers to the protein molecules degrades the purity of the milk proteins. After the process of reconstituting the CMPs, the milk protein molecule is no longer considered a pure milk protein, and loses much of its functionality. As an example, Casein that has been mated to an emulsifier such as Sodium is known as “Sodium Caseinate” which is no-longer considered a pure milk derived protein. Since the CMPs produced in the preferred embodiment are derived in a liquid form and are maintained in that form throughout further processing, no mating of an emulsifier is needed thereby creating an all natural protein in the form of casein and whey protein concentrates (“WPC”) that can be further processed into various desired products.

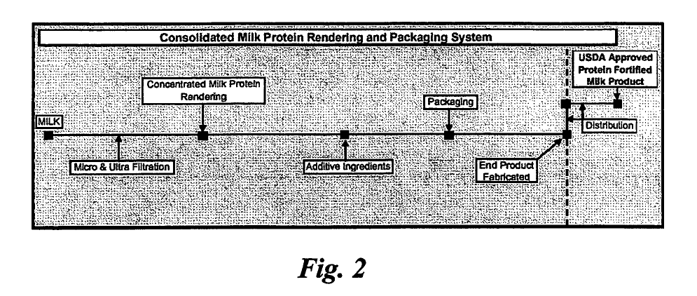

One general overview of the system is shown in FIG. 2. The consolidated system begins initially by filtering milk in one or more steps, preferably including a microfiltration step and an ultrafiltration step. One output from the filtration is the “retentate,” as discussed further below. The retentate may take a variety of forms, but preferably comprises a particular “mass balance” that is high in protein and low in fat. After production of the retentate, one or more ingredients is added in order to provide flavoring, vitamins, or other aspects. The retentate may alternatively be used in the production of ice cream, cheese, or other food products, as further described below. The resulting consumable is then packaged and distributed for ultimate sale.

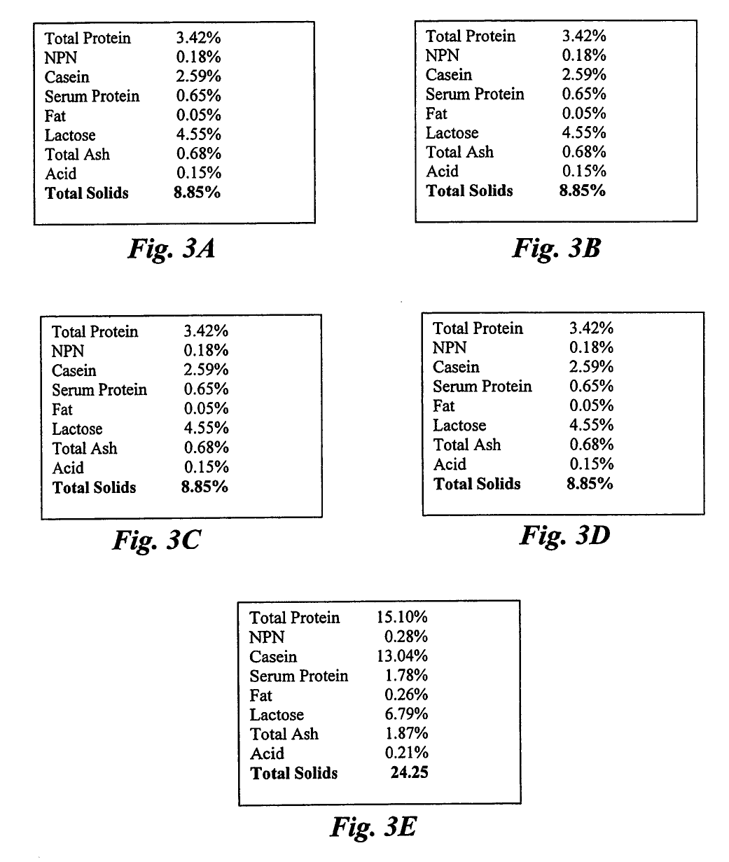

The initial process begins with raw milk that is preferably unprocessed. The milk then is processed by separating the cream and pasteurizing the milk. Equipment for cream separation and pasteurization is readily available. The pasteurization and separation step is performed on whole milk in order to produce a milk-based liquid having the characteristics shown in FIG. 3A.

The milk configuration above is then further processed in a microfiltration step. The filtration equipment and suitable filtration membranes for producing the desired characteristics are commercially available. The particular filtration membrane and processing is chosen to produce the retentate output configuration for the CMP base, as shown in FIG. 3B.

The CMP base is then diluted with water sourced from the original permeate stream which is polished via reverse-osmosis to either of the two output configurations shown in FIG. 3C or 3D (among others), one considered preferable for the subsequent production of diet shakes, and one considered preferable for a concentrated protein milk beverage.

After dilution, the liquid is filtered again as described in the microfiltration step in order to concentrate the retentate even further to achieve the preferred output configuration of FIG. 3E.

As is indicated from the mass balance, the resulting liquid is extremely high in protein while very low in fat (or non-fat, pursuant to USDA and/or FDA known standards).

The above filtered retentate configurations (that is, after either one or two filtration steps) are next mixed with natural or artificial flavors to achieve any one of the following flavors: Chocolate, dark chocolate, vanilla, strawberry, root beer float, banana split, caramel, blueberry, grape, chocolate/vanilla swirl, butter pecan, cookie dough, mocha java, coffee, peach, cheese cake, raspberry, blackberry and peanut butter.

In addition, or in the alternative, the retentate configurations above are blended with natural or artificial coloring to achieve any of the following colors: Chocolate brown, strawberry red, raspberry red, root beer brown, peach, purple, blue, green, banana yellow, blackberry, tan, coffee, and peanut butter.

In addition, or in the alternative, the process fortifies one or more of the retentate configurations shown above with vitamins or minerals, such as the USDA recommended daily allowance (100% for a 2,500 calorie diet) of 11 vitamins and minerals per 8 ounce serving pursuant to the following schedule:

A B Vitamin (Niacinamide), Vitamin E (Tocopheryl Acetate), Vitamin C (Sodium Ascorbate), Trisodium Phosphate, A B Vitamin (Calcium Pantothenate), Vitamin B₆ (Pyridoxine Hydrochloride), Vitamin B₂ (Riboflavin), Vitamin B, (Thiamin Mononitrate), A B Vitamin (Folic Acid), Vitamin A (Palmitate), Vitamin B₁₂, Vitamin D, Zinc and Iron.

In addition, or in the alternative, the process blends the retentate configuration shown in either Step #3 or Step #4 with Sucralose (up to 15 grams per 8 ounce serving) or any other natural or artificial sweetener.

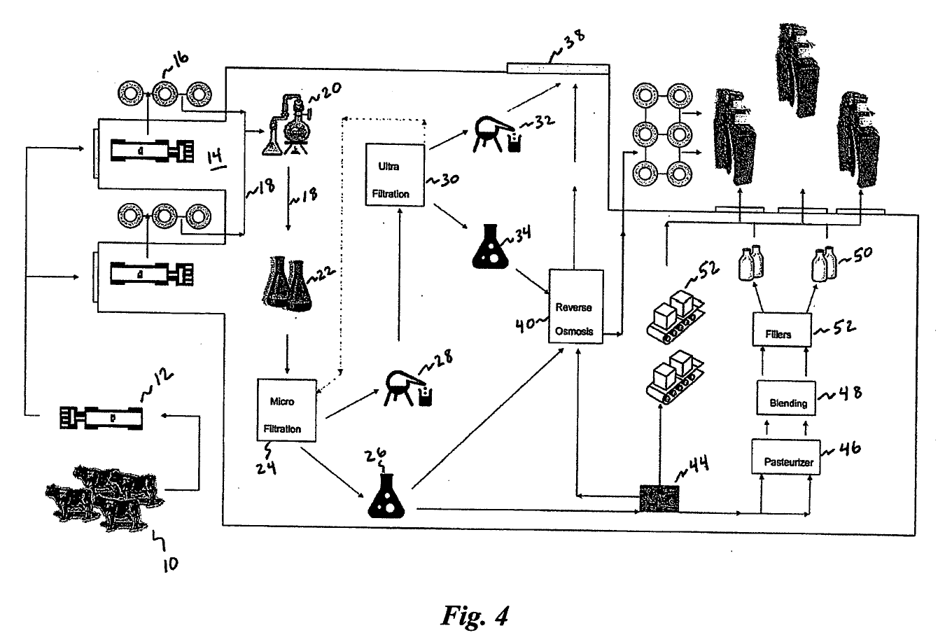

A further overview of the preferred embodiment of the invention is illustrated in FIG. 4. In this form, as with the foregoing preferred embodiment, the system is shown as a dairy processing facility in which there is a continuous flow of the process from milking dairy cows through the distribution of final consumable products.

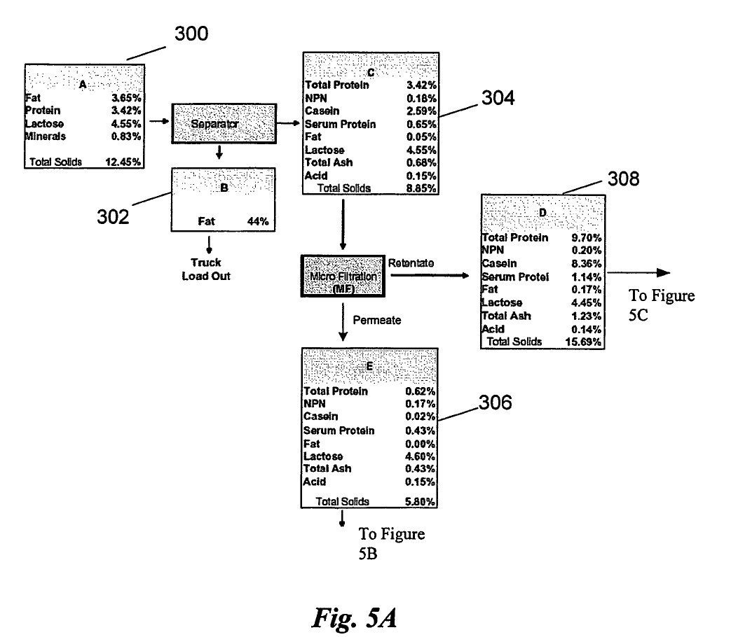

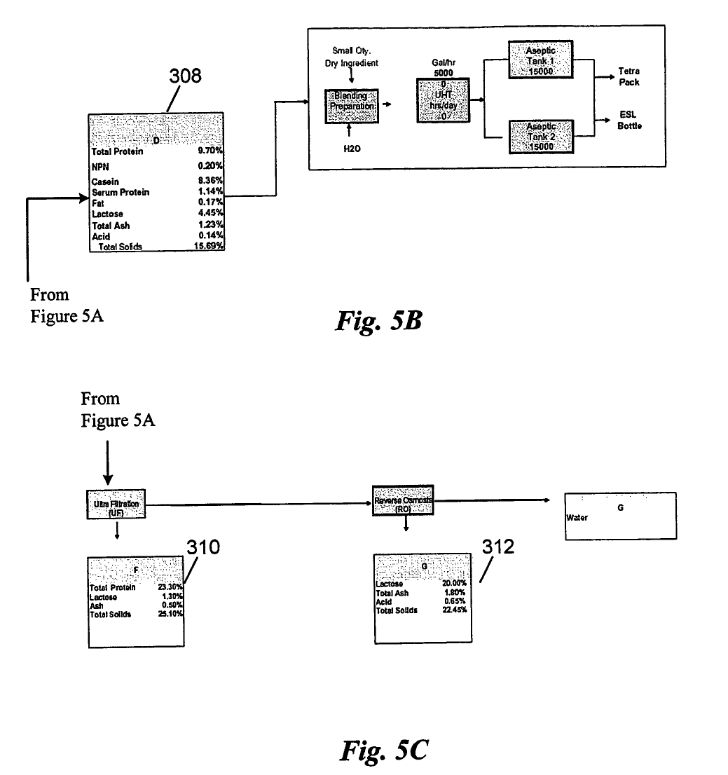

Initially, dairy cows 10 at any location provide milk that is transported via tank trucks 12 to receiving bays 14 at one end of the facility. Any number of trucks and receiving bays may be incorporated for this purpose. Likewise, depending on the location of the dairy farm, the milk may be delivered to the facility from the milking station via pipes or similar means. The composition of the milk as it is processed in the facility of FIG. 4 is shown in FIGS. 5A-C. The milk at the time it is received and stored within the silos is indicated in FIG. 5A at block 300, listing exemplary relative concentrations of fat, protein, lactose, and minerals. It should be understood that the values in block A may vary depending on a variety of factors related to the raising of cattle and the production of milk at the dairy.

Once at the facility, the trucks 14 unload the milk into one or more receiving silos 16. Any number of silos may be used, depending on the size of the facility and the quantity of milk processed. Likewise, while silos are used in the preferred embodiment, smaller tanks or other milk receiving or holding devices may also be used.

The milk within the silos 16 is conveyed via pipes 18 to a pasteurizer 20, which pasteurizes the raw milk. In a preferred form, a standard heating process is used for pasteurization. Any other method of pasteurization may be used, consistent with the invention. For that matter, the pasteurization step is not essential, but may be a desired or required step in standard dairy product processing. As yet another alternative, the milk may be pasteurized at the dairy farm or another location prior to delivery to the facility and receipt within the silos 16. Following pasteurization, the milk will still contain the relative concentrations indicated in block 300.

Following pasteurization, the milk is delivered, through additional pipes 18 to a cream separator 22 where the cream is removed from the whole milk, with the remaining dairy product homogenized (optionally) after the separation. It should be noted that, although not shown in most cases in FIG. 4, any number of pumps and valves are incorporated within the system as necessary to control the flow of milk from one processing station to another. In the preferred form, the cream separator comprises a centrifuge.

One of the key aspects of the preferred form of the invention is the separation of cream at a very high level. Preferably, the fat content of the separated cream will exceed 42 percent, and ideally it will be at a level of 44 percent or more, as indicated in block 302 in FIG. 5. The separation of cream at such a high concentration of fat provides for cream that is particularly well-suited for use in premium ice creams, and also produces a remaining dairy product having unique qualities. The cream is then packaged, pumped into a tank for delivery to another location, or placed in a storage tank for subsequent use in making ice cream or other products within the same facility. The remaining processing steps depicted in FIG. 4 relate to the processing of the portion of the whole milk that remains after the cream has been separated.

The product remaining after typical separation of cream from whole milk is classified as skim milk. In the preferred form as depicted in FIG. 5A, however, the amount of cream that has been removed from the milk exceeds the amount that is removed even to produce skim milk (according to known standards of identity for skim milk). Accordingly, the remaining dairy product after separation does not qualify as skim milk, is not marketable as such, and might well be discarded because it has no readily appreciated uses. The composition of the remaining product is indicated at block 304. As shown, the preferred fat concentration is a very low 0.05 percent while the protein concentration remains high.

The remaining milk product is then passed through a microfiltration membrane 24, which produces a first permeate 28 and a first retentate 26. The permeate following microfiltration has a preferred composition as indicated in block 306, while the retentate has a preferred composition as indicated in block 308. The retentate is high in protein and casein while relatively low in concentration of fat and other components. The permeate, however, is also relatively high in total protein and lactose concentration while containing virtually no fat.

The permeate 28 is then passed through an ultrafiltration membrane 30, which produces a second permeate 32 and a second retentate 34. The second permeate 32 is comprised primarily of water and lactose, as indicated in block 310. For that reason, a portion of the permeate purified using reverse osmosis or diafiltration, then fed back via pipes 36 and reused to aid in the microfiltration process at block 24. The remaining permeate 32 is transferred to a wastewater pretreatment block 38, where reverse osmosis, addition of enzymes, or other processes are used to remove lactose and much of the remaining other compounds (see block 312, consisting primarily of lactose) so that the water can be disposed of properly. The lactose 312 can alternatively be dried and bagged for subsequent sale as a separate product.

The second retentate 34 isolates the serum proteins found only in this permeate and contains virtually no fat. It is also very low in lactose and other components, as indicated in block 308. The second retentate is optionally passed to a reverse osmosis condenser 40 to further concentrate the composition, then transferred to storage tanks or silos 42 for subsequent distribution or incorporation into other products.

Because the second retentate 34 is very high in serum protein but contains no fat and very few other compounds, it is essentially a protein-fortified water. It may therefore be readily used to add protein in a liquid form to other beverages (for example, sodas or sport drinks) or other food products. As shown in FIG. 4, the second retentate is preferably housed for shipment to other beverage or food processing facilities where it is incorporated into such products. Alternatively, the same facility may include additional food or beverage processing systems, drawing directly from the tanks or silos 42 to use the second retentate in any amount as desired.

One advantage of the second retentate is that it is readily useful as a concentrated protein in liquid form. Unlike prior art processes for producing dairy proteins, it is not dried using heat or other such systems that denature the protein. Rather, it is produced in a system that maintains the protein at all times in liquid form, making it readily useful without drying and subsequent rehydration prior to use.

The first permeate 26 may also be used as-is, or can be delivered to a reverse osmosis condensing station 40 for further concentration. As with the second retentate 34, concentrating the first permeate is a useful step in the event it is to be shipped via tanker truck in large volumes to another facility for use in additional products. Thus, after reverse osmosis, the first permeate is transferred to storage silos 42 to await later shipment.

Within the facility, however, the first permeate may be packaged in a variety of forms. The composition of the first permeate 26, as shown at block 308, is such that it is high in protein, low in fat, but also includes lactose and certain other milk compounds. The composition of the first permeate 26 is such that it has a similar “mouth feel,” taste, and color as typical milk, but with very high protein and virtually no fat. Preferably, the composition is greater than eight percent total protein, seven percent casein, and less than 0.3 percent fat. In one preferred embodiment, as shown at block 308, the composition is 9.7 percent total protein, 8.36 percent casein, and 0.17 percent fat. Accordingly, the first retentate can be packaged in a variety of ready to drink containers, bag-in-box fillers, or other such packages for a dairy beverage that is ready to drink. A directional valve 44 is used to control the flow of the first permeate to the desired processing and packaging route.

As desired, or as necessary, the first permeate may be pasteurized a second time at a pasteurizer 46. The first permeate may also be blended with other liquid or dry ingredients such as flavorings, as described above, at a blending and processing station 48. Finally, the product is packaged using beverage fillers 52, and passed to shipping bays for ultimate distribution to consumers or retailers.

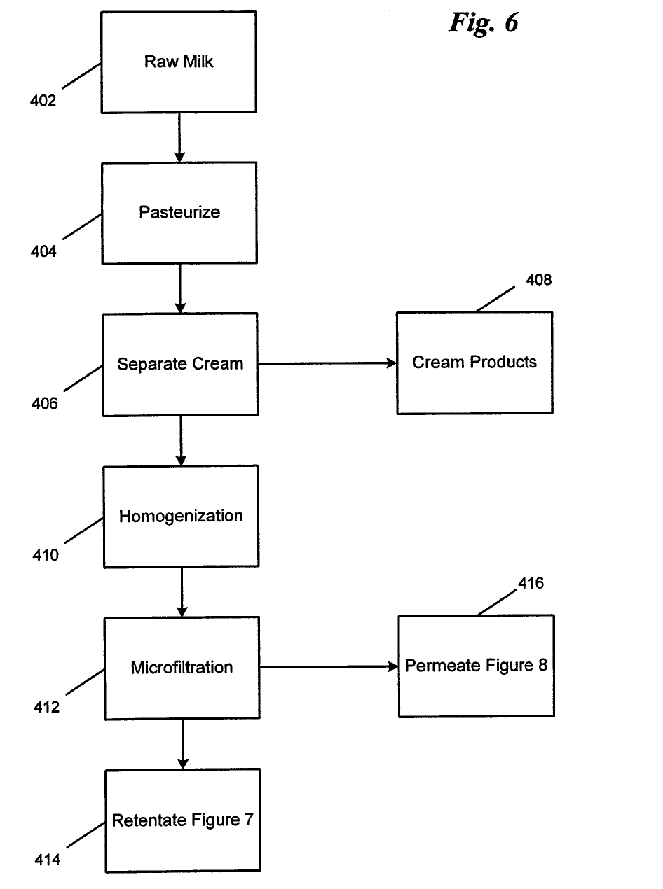

A flow diagram for producing milk-based liquids, beverages, and other products using the system described above is provided in FIG. 6. At a first block 402, raw milk is provided, preferably trucked in from nearby dairies but alternatively obtained from a dairy associated with the processing plant.

The raw milk is pasteurized 404 and then delivered to a centrifuge for separation of the cream 406. In accordance with most preferred embodiments of the invention, the cream separation step removes the cream such that the cream preferably comprises at least 42 percent fat, and ideally greater than 44 percent fat. The cream is then used directly as cream or alternatively to produce ice cream or other cream products 408.

The remaining milk-based liquid after the cream has been removed is very low in fat and is further processed to produce other preferred milk-based products. The milk, after cream removal, is homogenized 410 (optionally) and then microfiltered 412. The microfiltration produces a first retentate 414 and a first permeate 416.

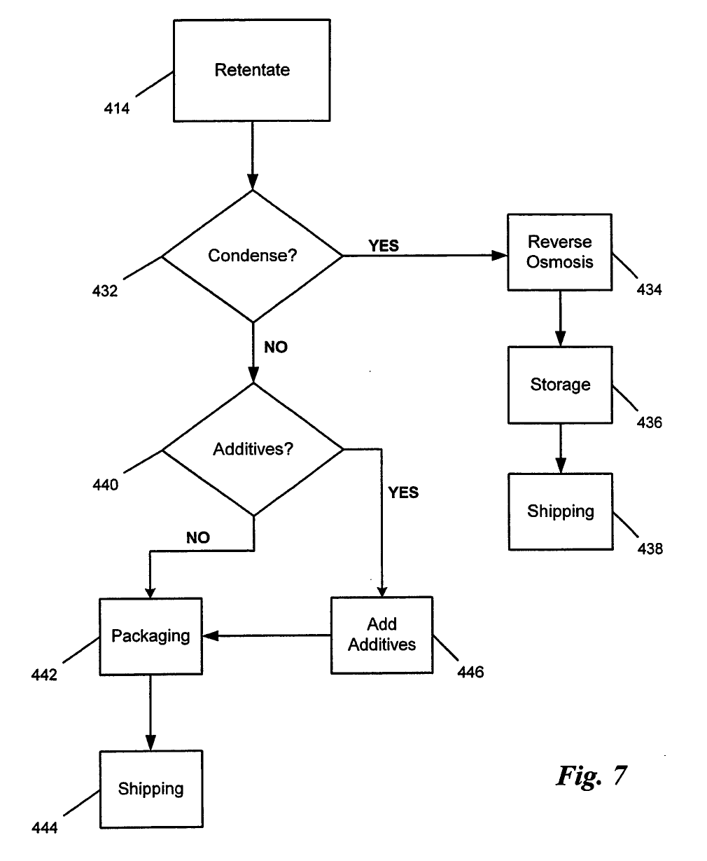

After production of the first retentate 414 (see FIG. 7), the process proceeds to a decision block 432 for optional condensation of the retentate. If it is desired to further condense the retentate, the process proceeds to block 434 where the liquid is condensed using reverse osmosis. After it is concentrated to the desired level, the liquid is stored 436 (if desired) and subsequently shipped 438. The storage step may be omitted and, instead, the liquid may be shipped without an intermediate storage.

If the product is not concentrated, it is ready for consumption as a milk-based beverage that, as described above, is very high in protein, has virtually no fat, and has a mouth feel that is similar to whole milk that includes a much higher level of fat. The product produced at this step in the process preferably includes greater than 9 percent total protein and greater than 7 or 8 percent casein. As compared to raw milk, there is more than double the amount of protein with substantially no fat.

The ready-to drink product may be enhanced with additives, as desired at a decision block 440. Additives may include, for example, flavorings, vitamins, or other ingredients, and are added at block 446. The blended beverage, or unmodified retentate, are packaged at block 442. The packaging may be in a variety of forms, such as ready to drink containers, gallon or similar containers, or bag-in-box fillers. After packaging, the products are ready for shipment 444 to wholesalers, retailers, or consumers.

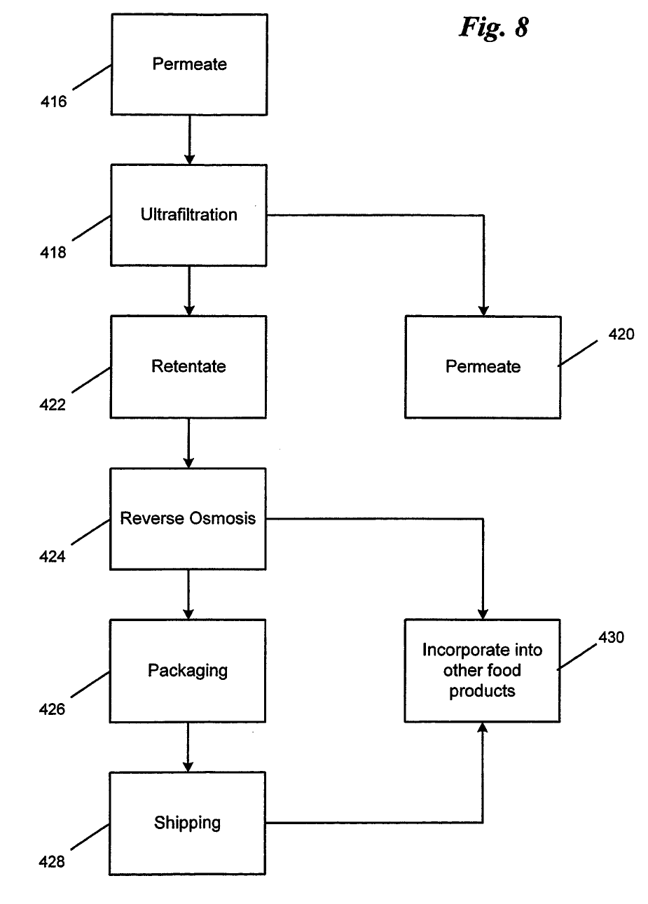

The first permeate (block 416 in FIGS. 6 and 8) is also further processed for subsequent use in a variety of products. At block 418, the first permeate undergoes ultrafiltration, which produces a second permeate 420 and a second retentate 422. The second permeate primarily includes lactose and water, and undergoes optional diafiltration for further use in the microfiltration step above to isolate additional milk solids. The remaining second permeate is processed to remove the lactose and any other elements for eventual disposal as wastewater. Optionally, the lactose may be removed and dried for use in other products.

The second retentate at 422 is then concentrated (if desired) in a reverse osmosis step 424. The concentrated second retentate is packaged 426 or stored for subsequent shipment 428. Following shipment (or optionally at the same facility), the second retentate (which isolates the serum proteins) is added to other food or beverage products as a means for protein fortification for such products. The composition of the second retentate (see 308 in FIG. 5) is such that it is very high in protein but very low in other components. In the preferred form, the second retentate contains essentially no fat, about one third the original lactose of raw milk, and more than six times the amount of protein as a percentage of the total solids. The high protein and very low level of other ingredients, particularly fat, makes the second permeate especially useful for protein fortification.

In addition, the second permeate is preferably used in its liquid state, without drying the protein and rehydrating it for later use. As such, it can be directly added to other beverages, including water, sodas, sports drinks, or other non-dairy beverages, as a natural protein supplement. As noted above, this protein fortification can occur at the same facility or at other remote beverage or food processing facilities.

The desired level of protein fortification can vary according to preference, but in accordance with a preferred embodiment an amount of the second permeate is added to a beverage such that it comprises approximately 1 to 3 percent of the beverage by volume. Alternatively, by weight, an amount of the second permeate is added so that a 16 ounce beverage serving contains approximately 5 to 15 grams of serum protein.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for making a composition obtained from milk, comprising:
separating cream from the milk such that greater than about 42 percent of fat from the milk has been removed with the cream to produce an ultra low-fat milk product; and
microfiltering the milk product.

2. The method of claim 1, wherein the milk comprises whole milk.

3. The method of claim 1, wherein the milk comprises skim or low fat milk originally obtained from whole milk, and further where the step of separating the cream further comprises removing cream from the milk such that greater than about 42 percent of the fat has been removed from the amount of fat originally present in the whole milk.

4. The method of claim 1, wherein the step of separating the cream further comprises separating the cream from the milk such that greater than about 44 percent of the fat from the milk has been removed.

5. The method of claim 4, wherein the step of microfiltering is performed such that the milk product comprises total protein in an amount greater than about 8 percent of the total weight and fat in an amount less than about 0.3 percent of the total weight.

6. The method of claim 4, wherein the step of microfiltering is performed such that the milk product comprises total protein in an amount greater than about 9 percent of the total weight and fat in an amount less than about 0.2 percent of the total weight.

7. The method of claim 4, wherein the step of microfiltering is performed such that the milk product comprises total protein in an amount greater than about 9 percent of the total weight, casein in an amount greater than about 8 percent of the total weight, and fat in an amount less than about 0.2 percent of the total weight.

8. The method of claim 7, further comprising adding at least on additive.

9. The method of claim 8, wherein the additive comprises a flavoring.

10. The method of claim 7, further comprising packaging the composition in a ready-to-drink container.

11. A method for making a composition obtained from milk, comprising:
separating cream from the milk such that greater than about 42 percent of fat from the milk has been removed with the cream to produce an ultra low-fat milk product;
microfiltering the milk product to produce a first permeate and a first retentate; and
ultrafiltering the first retentate to produce a second permeate and a second retentate.

12. The method of claim 11, wherein the milk comprises whole milk.

13. The method of claim 11, wherein the milk comprises skim or low fat milk originally obtained from whole milk, and further where the step of separating the cream further comprises removing cream from the milk such that greater than about 42 percent of the fat has been removed from the amount of fat originally present in the whole milk.

14. The method of claim 11, wherein the step of separating the cream further comprises separating the cream from the milk such that greater than about 44 percent of the fat from the milk has been removed.

15. The method of claim 14, wherein the step of ultrafiltering is performed such that the second retentate comprises total protein in an amount greater than about 10 times the other solids by weight.

16. The method wherein the step of ultrafiltering is performed such that the second retentate comprises substantially no fat.

17. The method of claim 14, wherein the step of ultrafiltering is performed such that the second retentate comprises total serum proteins in amount greater than about 20 percent by weight, and substantially no fat.

18. The method of claim 17, further comprising adding a portion of the second retentate to a beverage in a sufficient amount to provide a desired level of serum protein fortification to the beverage.

19. The method of claim 18, wherein the second retentate is not dried prior to being added to the beverage.

20. The method of claim 18, wherein the beverage comprises water.

21. The method of claim 18, wherein the beverage comprises fruit juice.

22. The method of claim 18, wherein the beverage comprises soda.

23. The method of claim 18, wherein the beverage comprises a non-carbonated beverage.
